(19) United States
(12) Patent Application Publication
(10) Pub. No.: US 2024/0175754 A1
(43) Pub. Date: May 30, 2024

(54) CONFIGURABLE DIGITAL BLOCK FOR INFRARED SENSORS

(71) Applicant: STMICROELECTRONICS S.r.l., Agrate Brianza (IT)

(72) Inventors: Luca Gandolfi, Milano (IT); Ugo Garozzo, Milano (IT)

(73) Assignee: STMICROELECTRONICS S.r.l., Agrate Brianza (IT)

(21) Appl. No.: 18/060,501

(22) Filed: Nov. 30, 2022

(51) Int. Cl. G01J 5/02; G01J 5/24

(52) U.S. Cl. CPC G01J 5/027; G01J 5/24

(57) ABSTRACT

A sensor device includes an infrared sensor configured to generate sensor data. The sensor device also includes a configurable digital analysis block. The configurable digital analysis block is configured to generate classification data based on the sensor data. The configurable digital analysis block includes a plurality of selectable analysis blocks that can be selectively included in generating the classification data.

### BACKGROUND

### Technical Field

The present disclosure is related to infrared sensors, and more particularly to digital circuitry for processing infrared sensor signals.

### Description of the Related Art

In many situations it may be beneficial to determine if a user is present at an electronic device. For example, a user may operate an electronic device such as a smart phone, a tablet, or a laptop computer. If the user leaves the presence of the electronic device, it may be beneficial for the electronic device to turn off the display, deactivate an application, or stop running certain background processes. However, if the electronic device cannot determine when the user is present or is not present, then the electronic device may not be able to determine when to turn off or reduce the power of circuits, applications, or processes. It may be beneficial to detect the presence of the user for other reasons, such as security reasons.

Infrared sensors are one type of sensor that can be utilized in an electronic device to detect the presence of an individual. Infrared sensors may rely on detection of infrared light emitted by a user in order to determine if the user is present. One type of infrared sensor is a thermal metal oxide semiconductor (TMOS) sensors. The TMOS sensor may include a transistor that has a transconductance or other electrical properties that are sensitive to temperature. The TMOS sensor may include a material that absorbs infrared light, thereby increasing the temperature and changing the electrical properties.

It can be very difficult to properly process the sensor signals from the TMOS sensor in order to accurately detect the presence of the user. One possible solution is to provide a sensor signals from the TMOS sensor to an external microcontroller. The external microcontroller can then process the signals and determine whether a user is present. Another solution is to include a microcontroller with the TMOS sensor device. However, both of the solutions can be relatively expensive and can consume relatively large amounts of power.

The issues described above can also relate to the use of infrared sensors to detect the number of people entering or exiting an area. For example, it can be beneficial to know how many people have entered and exited a building, a room, or a particular area. This can be beneficial for security reasons, for logistical reasons, or for other reasons. A TMOS sensor can be utilized for this purpose. However, the drawbacks associated with processing signals for presence detection can also occur for the utilization of TMOS sensors for counting the number of people exiting or entering areas.

All of the subject matter discussed in the Background section is not necessarily prior art and should not be assumed to be prior art merely as a result of its discussion in the Background section. Along these lines, any recognition of problems in the prior art discussed in the Background section or associated with such subject matter should not be treated as prior art unless expressly stated to be prior art. Instead, the discussion of any subject matter in the Background section should be treated as part of the inventor's approach to the particular problem, which, in and of itself, may also be inventive.

### BRIEF SUMMARY

Embodiments of the present disclosure provide an infrared sensor device that includes an infrared sensor and a configurable digital analysis block. The digital analysis block includes a plurality of selectable analysis blocks for processing sensor signals associated with the infrared sensor. The digital analysis block can be selectively configured to utilize some or all of the selectable analysis blocks. The digital analysis block is able to process sensor signals without an internal or external microcontroller, though a microcontroller can be utilized with the digital analysis block if desired.

In one embodiment, the infrared sensor device includes a TMOS sensor that generates sensor signals. The digital analysis block includes a feature generation block, a neural network block, and a finite state machine block. The digital analysis block can be selectively configured to use the feature generation block, the neural network block, and the finite state machine block to make a classification based on the sensor signals. The digital analysis block can be selectively configured to use only the neural network block to classify the sensor signals. The digital analysis block can be selectively configured to use only the finite state machine to classify the sensor signals. The digital analysis block can be selectively configured to utilize the feature generator and the neural network to classify the sensor signals. The digital analysis block can be selectively configured to utilize the feature generator and the finite state machine to classify sensor signals.

The digital analysis block provides flexibility, efficiency, and accuracy in classifying sensor signals. The digital analysis block can be utilized to determine whether a user is present at an electronic device based on the sensor signals. The digital analysis block can be utilized to count the number of people entering or exiting an area based on the sensor signals.

In one embodiment, an electronic device includes a sensor device. The electronic device can include a mobile phone, a laptop computer, a tablet, or another type of electronic device. The sensor device can include an infrared sensor and a configurable analysis block. The configurable analysis block can be selectively configured with different combinations of selectable analysis blocks in order to process or classify the sensor signals. The infrared sensor can include a TMOS sensor or another type of sensor. While the description herein may focus primarily on embodiments in which a TMOS sensor is used for presence detection or counting people exiting or entering an area, principles of the present disclosure extend to other types of sensors and other types of classification.

### BRIEF DESCRIPTION OF THE SEVERAL VIEWS OF THE DRAWINGS

Reference will now be made by way of example only to the accompanying drawings. In the drawings, identical reference numbers identify similar elements or acts. In some drawings, however, different reference numbers may be used to indicate the same or similar elements. The sizes and relative positions of elements in the drawings are not necessarily drawn to scale. For example, the shapes of various elements and angles are not necessarily drawn to scale, and some of these elements may be enlarged and positioned to improve drawing legibility.

FIG. 1 is a block diagram of an integrated circuit, according to one embodiment.

FIG. 2 is a block diagram of a sensor device, according to one embodiment.

FIG. 3 is a block diagram of a configurable digital analysis block, according to one embodiment.

FIG. 4 is a block diagram of a feature generator of a configurable digital analysis block, according to one embodiment.

FIG. 5 is a block diagram of a memory of a feature generator, according to one embodiment.

FIG. 6 is a block diagram of a memory of a feature generator, according to one embodiment.

FIG. 7 is a diagram of a bike one cell of a feature generator, according to one embodiment.

FIG. 8 is a block diagram of a portion of a memory of a feature generator, according to one embodiment.

FIG. 9 is a block diagram of a portion of a memory of a feature generator, according to one embodiment.

FIG. 10 is a graph illustrating features generated by a feature generator, according to one embodiment.

FIG. 11 is a block diagram of a portion of a memory of a feature generator, according to one embodiment.

FIG. 12 is a graph illustrating features generated by a feature generator, according to one embodiment.

FIG. 13 is a block diagram of a portion of a memory of a feature generator, according to one embodiment.

FIG. 14A is a block diagram of a neural network, according to one embodiment.

FIG. 14B is a block diagram of input data for a neural network, according to one embodiment.

FIG. 15 is a block diagram of a finite state machine, according to one embodiment.

FIG. 16 is a block diagram of a memory of a finite state machine, according to one embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known systems, components, and circuitry associated with integrated circuits have not been shown or described in detail, to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.” Further, the terms “first,” “second,” and similar indicators of sequence are to be construed as interchangeable unless the context clearly dictates otherwise.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

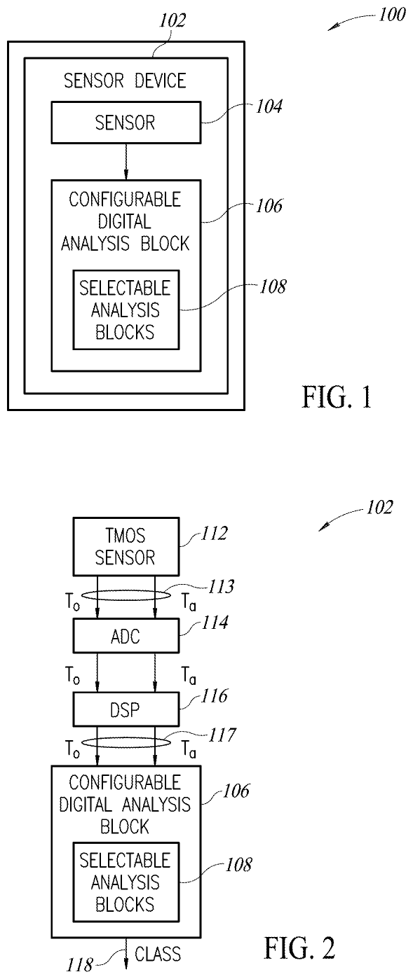

FIG. 1 is a block diagram of an electronic device 100 including a sensor device 102, according to one embodiment. The sensor device 102 includes one or more sensors 104. The one or more sensors 104 generate sensor signals. The sensor device 102 includes a configurable digital analysis block 106. The configurable digital analysis block 106 includes a plurality of selectable analysis blocks 108. As will be set forth in more detail below, the configurable digital analysis block 106 can be configured to utilize one or more of the selectable analysis blocks 108 to make classifications based on the sensor signals.

In one embodiment, the sensor device 102 may be part of the electronic device 100. The electronic device 100 may include a smart phone, a laptop computer, a tablet, or another type of electronic device. The sensor device 102 may be utilized to detect whether a user is present at the electronic device 100. The sensor device 102 may be positioned adjacent to a camera suite of the electronic device 100, or in another location of the electronic device 100.

In one embodiment, the sensor device 102 is utilized to detect the number of people entering or exiting a particular area. In these cases, the sensor device 102 may be placed at a location through which individuals pass. For example, the sensor device 102 may be placed at a doorway through which people pass to go into or out of a building, to go into or out of a room in a building, or to go into or out of other types of areas. The sensor device 102 may be placed in such a manner that individuals will pass from left to right or from right to left through the field of view of the sensor to enter or leave the doorway. The sensor device 102 can detect when an individual passes through the field of view of the sensor device 102 and the direction of travel of the individual.

The sensor device 102 includes a sensor 104. In one embodiment, the sensor 104 is an infrared sensor that is sensitive to infrared light. Humans more or less continuously emit infrared light. When an individual is in the field of view of the sensor 104, the sensor 104 detects the infrared light emitted by the individual. The sensor 104 generates sensor signals indicative of the infrared light received by the sensor 104.

In one embodiment, the sensor 104 is implemented in an integrated circuit die. For example, the sensor 104 may include a TMOS sensor implemented in an integrated circuit die. The TMOS sensor may correspond to a transistor having electrical properties that are highly sensitive to temperature. For example, the transconductance of the TMOS transistor may be highly sensitive to temperature. The integrated circuit may include a material that is transparent to infrared light. The infrared light may pass through the transparent region to the transistor. The infrared light is absorbed by the transistor, resulting in changes in temperature. The changes in temperature result in changes in the transconductance of the transistor. Accordingly, the TMOS sensor may output sensor signals based on voltages or currents associated with the TMOS transistor.

In one embodiment, the sensor 104 is a single pixel TMOS sensor. The use of a single pixel TMOS sensor results in very low power consumption. Furthermore, a TMOS transistor of the TMOS sensor may be operated in a sub threshold region, further reducing power consumption associated with the TMOS sensor. Alternatively, the sensor 104 may include a multi-pixel TMOS sensor.

In one embodiment the sensor 104 can include signal processing circuitry that generates digital sensor data from analog sensor signals. As used herein, sensor signals may correspond to the raw analog signals output in conjunction with a TMOS transistor. As used herein, sensor signals may also correspond to digital sensor data that results from signal processing of the analog sensor signals. The signal processing circuitry may be part of the same integrated circuit die in which the sensor 104 is implemented. The signal processing circuitry may convert analog sensor signals to digital sensor data in preparation for analyzing the digital sensor data.

The sensor device 102 includes a configurable digital analysis block 106. The configurable digital analysis block 106 is coupled to the sensor 104 and receives sensor data from the sensor 104. As described above, there may be analog-to-digital conversion circuitry, or other types of digital processing circuitry between the sensor 104 and the configurable digital analysis block 106. The configurable digital analysis block 106 receives sensor data corresponding to digital versions of analog sensor signals generated by the sensor 104.

In one embodiment, the configurable digital analysis block 106 and the sensor 104 are implemented in a single integrated circuit. For example, the configurable digital analysis block 106 and the sensor 104 may be implemented in a single system on chip (SoC). Alternatively, the configurable digital analysis block 106 and the sensor 104 may be implemented in separate integrated circuit dies. The multiple integrated circuit dies of the configurable digital analysis block 106 and the sensor 104 may be packaged together in a single molded package. Alternatively, the integrated circuit dies of the configurable digital analysis block 106 and the sensor 104 may be in separate molded packages. In one embodiment, the configurable digital analysis block 106 and the sensor 104 are implemented on a printed circuit board. Signal traces may conduct sensor signals from the sensor 104 to the configurable digital analysis block 106.

In one embodiment, the configurable digital analysis block 106 is a classifier. The configurable digital analysis block 106 receives raw sensor data and generates a classification based on the raw sensor data. In the example in which the sensor device 102 detects the presence of a user of an electronic device, the configurable digital analysis block 106 receives the raw sensor data, analyzes the raw sensor data, and generates a classification indicating whether or not the user is present. In an example in which the sensor device 102 is utilized to count the number of people entering or exiting an area, the configurable digital analysis block 106 analyzes the raw sensor data and generates a classification indicating whether or not an individual has passed through the field of view of the sensor device 102. The configurable digital analysis block 106 can be utilized to generate other types of classifications without departing from the scope of the present disclosure.

The configurable digital analysis block 106 includes a plurality of selectable analysis block 108. The selectable analysis blocks 108 correspond to digital circuits that classify, or assist in classifying the sensor data from the sensor 104. The configurable digital analysis block 106 can be selectively configured to utilize or not utilize any of the selectable analysis blocks 108 in classifying the sensor data. Any selected combination of the selectable analysis blocks 108 is capable of generating classifications for the sensor data.

The speed, accuracy, and power efficiency of the configurable digital analysis block 106 may depend on the selected combination of the selectable analysis blocks 108. For example, selecting all of the selectable analysis blocks 108 may result in a very high accuracy with a slight reduction in speed and a slight increase in power consumption, though all combinations of selectable analysis blocks 108 may result in relatively high accuracy, high speed, and low power consumption. Selecting only one of the selectable analysis blocks 108 may result in a higher classification speed, a lower power consumption, and a slightly reduced accuracy.

In one embodiment, the selectable analysis blocks 108 include one or more of a feature generation block, an analysis model trained with a machine learning process, a finite state machine, or other types of analysis blocks. Each of these selectable analysis blocks 108 may be actively used in the classification, or may be bypassed. As used herein, the term “raw sensor data” corresponds to sensor data that has not yet passed through any of the selectable analysis blocks 108.

In one embodiment, the configurable digital analysis block 106 can classify sensor data from the sensor 104 without the use of a microcontroller. Possible classification solutions can include the use of a microcontroller external to the sensor device 102 or internal to the sensor device 102. These possible solutions may result in increased cost, area consumption, power consumption, and overall complexity. The configurable digital analysis block 106 can process and classify the sensor data without the use of a microcontroller. However, in some embodiments, the configurable digital analysis block 106 can also be implemented in conjunction with a microcontroller.

FIG. 2 is a block diagram of a sensor device 102, according to one embodiment. The sensor device 102 of FIG. 2 is one example of a sensor device 102 of FIG. 1. The sensor device 102 includes a TMOS sensor 112. The TMOS sensor 112 is one example of a sensor 104 of FIG. 1. As described previously, the TMOS sensor can include one or more TMOS transistors. Other types of passive infrared sensors can be used in place of the TMOS sensor 112.

Though not shown in FIG. 2, the sensor device 102 can include one or more lenses. The one or more lenses can direct or focus infrared light from individuals onto the TMOS sensor 112. For example, the lenses may direct or focus infrared light onto an opening or transparent region of the TMOS sensor 112 to the temperature sensitive region of the TMOS sensor 112.

In one embodiment, the TMOS sensor 112 generates two analog sensor signals 113. A first analog sensor signal is indicative of the temperature of an object. The object may correspond to a human in the field of view of the TMOS sensor 112. The second analog sensor signal is indicative of the ambient temperature. This is the temperature in the environment of the TMOS sensor 112. The object temperature may be designated by “To”. The ambient temperature may be designated by “Ta”. The designations To and Ta will be utilized for both the analog signals generated directly by the TMOS sensor 112 as well as for digital sensor data generated from the analog sensor signals. Accordingly, To and Ta can refer to both analog sensor signals and digital sensor data.

In one embodiment, the sensor device 102 includes an analog-to-digital converter (ADC) 114. The ADC 114 receives the analog temperature signals To and Ta and converts them to digital temperature signals To and Ta.

In one embodiment, the sensor device 102 includes a digital signal processor (DSP) 116. The DSP 116 receives the digital sensor data To and Ta from the ADC 114 and may perform one or more digital signal processing steps on the sensor data. Such digital signal processing steps can include filtering, noise reduction, or other conditioning steps that may prepare the digital sensor data for further processing by the configurable classifier 106. The DSP outputs sensor data 117 including To and Ta.

The configurable digital analysis block 106 may correspond to a configurable classifier. The digital signal analysis block 106 receives the sensor data 117 from the DSP 116. Although the configurable digital analysis block 106 may receive the sensor data from a component or circuit positioned intermediate to the TMOS sensor 112 and configurable digital analysis block 106, the configurable digital analysis block can be said to receive the sensor data from the TMOS sensor 112.

In one embodiment, the configurable digital analysis block 106 processes the sensor data 117 and generates classification data 118. In the example in which the sensor device 102 is configured to detect the presence of the user, the classification data can indicate whether or not the user is present. In the example in which the sensor device 102 is configured to detect a person passing through the field of view of the sensor device 102, the classification data 118 may indicate no crossing, crossing from left to right, or crossing from right to left. The configurable digital analysis block 106 can make various types of classifications based on the sensor data without departing from the scope of the present disclosure.

The configurable digital analysis block 106 includes selectable analysis blocks 108. The selectable analysis blocks 108 include one or more analysis blocks that can be selectively used or not used in processing the sensor data 117 in order to generate the classification data 118. The user can configure the configurable digital analysis block 106 to implement a single selectable analysis block 108 or any combination of selectable analysis blocks 108 to generate classification data 118. Further details regarding the configurable digital analysis block 106 are provided below.

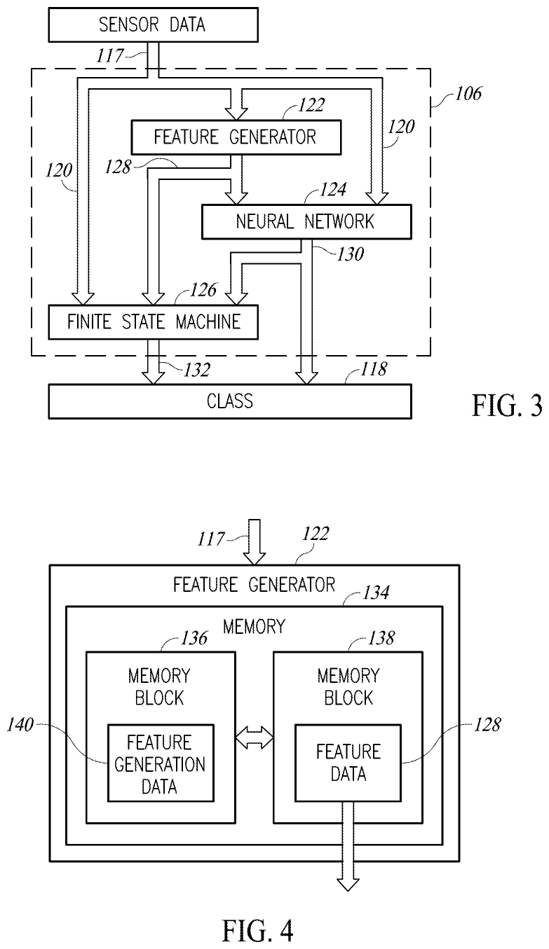

FIG. 3 is a block diagram of a configurable digital analysis block 106, according to one embodiment. The configurable digital analysis block 106 of FIG. 3 is one example of a configurable digital analysis block 106 of FIGS. 1 and 2. The configurable digital analysis block 106 includes a plurality of selectable analysis blocks including a feature generator 122, a neural network 124, and the finite state machine 126. Other types of selectable analysis blocks and other combinations of selectable analysis blocks can be utilized without departing from the scope of the present disclosure.

The configurable digital analysis block 106 receives the sensor data 117. In one embodiment, the sensor data 117 includes an object temperature To and an ambient temperature Ta. The unprocessed sensor data 117 may be provided to each of the selectable analysis blocks. In particular, the sensor data 117 may be provided as input data to the feature generator 122, the neural network 124, and the finite state machine 126. A user may configure the configurable digital analysis block 106 to use one or more of the selectable analysis blocks to generate classification data 118. The configurable digital analysis block 106 can include configuration data that indicates which of the selectable analysis blocks 108 will be utilized, which inputs will be provided to the selectable analysis blocks, and what will be output by the selectable analysis blocks.

In one embodiment, the feature generator 122 receives the sensor data 117 and generates feature data 128. In particular, the feature generator 122 may receive the sensor data 117 and a process the sensor data 117 to generate one or more features. In one example, the feature generator 122 can receive Ta and To and can generate a recursive maximum, a recursive minimum, a variance, a recursive variance, a linear combination of feature values, a derivative, or other types of features.

In one embodiment, the feature generator 122 outputs, for each sample of the sensor data 117, a feature vector. The feature vector includes a plurality of data fields. Each data field corresponds to a feature generated by the feature generator 122. Furthermore, each feature vector can include the sensor data 117. Although features are generated from the sensor data 117, in practice, the values of the sensor data can also be considered features when they are included in the feature vector provided by the feature generator 122. In one example, the feature generator 122 outputs a feature vector that includes five data fields. A first data field may be Ta from the sensor data 117, a second data field may be To from the sensor data 117, a third data field may include the recursive variance generated from the sensor data 117, a fourth data field may include the recursive maximum generated from the sensor data 117, a fifth data field may include the recursive minimum generated from the sensor data 117. Various other types of features and combinations of features can be utilized for a feature vector of the feature data 128 without departing from the scope of the present disclosure. A user may configure the configurable digital analysis block 106 to utilize or to not utilize the feature generator 122.

In one embodiment, the neural network 124 receives the sensor data 117 and/or the feature data 128 from the feature generator 122 and generates classification data 130. In one embodiment, the configurable digital analysis block 106 may be selectively configured so that the output of the neural network 124 corresponds to the classification data 118. In these cases, the finite state machine 126 is selectively disabled. Alternatively, the configurable digital analysis block 106 may be selectively configured so that the output 130 of the neural network 124 is provided to the finite state machine 126 for further processing. Accordingly, the output of the neural network 124 may be the final output of the configurable digital analysis block 106 or may be the input to another selectable analysis block.

In one embodiment, the neural network 124 is a quantized neural network. The neural network 124 may receive a plurality of sets of sensor data 117 or a plurality of feature vectors from the feature generator 122. The neural network 124 processes the plurality of sets of sensor data 117 or the plurality of vectors from the feature generator 122 and generates the classification data 130.

The neural network 124 may to be trained with a machine learning process to generate classification data based on one or both of the sensor data 117 and the feature data 128. The machine learning process can include training the neural network 124 with training set data. The training set data includes a plurality of sets of data. Each set of data includes a label and either or both of the feature data 128 and the sensor data 117. The label corresponds to an indication as to whether a particular set of input data corresponds to one classification or another (i.e., user present or not present, in the example of a presence detector). The sensor training set data are passed to the neural network 124 in iterations and the neural network 124 is trained to accurately predict the correct label for each set of the training data. Further details regarding the training process are provided below.

The finite state machine 126 selectively receives the sensor data 117, the feature data 128, and the classification data 130. In other words, a user can configure the configurable digital analysis block 106 to utilize any combination of the sensor data 117, the output of the feature generator 122, and the output of the neural network 124. The finite state machine 126 processes the input data and generates classification data 132. The classification data 132 may correspond to the final classification data 118 of the configurable digital analysis block 106. Alternatively, the user can selectively configure the configurable digital analysis block 106 to not utilize the finite state machine 126.

In one embodiment, the finite state machine 126 can include a Moore machine. The Moore machine generates the output values determined only by its current state. Parameters that can be set for the Moore machine can include a state, an arc command/condition, a state command, or other types of parameters. The finite state machine 126 can include a state memory used to store logic commands, a command memory used for arc and state commands, and an input memory, to store input data such as the sensor data 117, the classification data 130, timer data, constants data and other types of data.

The output of the configurable digital analysis block is classification data 118. The classification data 118 can correspond to the classification data 132 output from the finite state machine 126 if the finite state machine 126 is selected for use. The classification data 118 can correspond to the classification data 130 from the neural network 124 if the neural network 124 is selected for use in the finite state machine 126 is not selected for use. Various other configurations can be utilized without departing from the scope of the present disclosure.

FIG. 4 is a block diagram of a feature generator 122, according to one embodiment. The feature generator 122 receives the sensor data 117. The feature generator 122 is configured to extract information about the movement of an object (i.e., a person) in the field of view of the sensor 104 based on the sensor data 117. As set forth previously the sensor data 117 can include the ambient temperature Ta and the object temperature To.

In one embodiment, the feature generator 122 includes one or more biquad cells. The biquad cells can be configured to filter the DC value from the sensor data, to filter noise from the sensor data, and to select bands of interest of the movement of the object.

The feature generator 122 can be configured to compute the variance of Ta and To. The variance may be correlated with the movement of the object.

The feature generator 122 may include envelope detectors. The envelope detectors may generate envelope data defining maximum and minimum values within which the sensor data is confined. This can help to smooth the input data in case of a fast event, such as the entrance or exit of a user into the field of view of the sensor 104.

In one embodiment, the feature generator 122 can generate a time the street derivative from the sensor data 117. The time the street derivative can include information on how the sensor data or a particular feature changes, thereby helping discriminate the type of movement of the object.

In one embodiment, the feature generator 122 can generate linear combinations of the input data 117. For example, the feature generator 122 can perform algebraic summation or subtraction of inputs. This is an inexpensive operation that allows the possibility of building complex functions.

In one embodiment, each of the features can be calculated recursively. This means that the feature generator may need to store in memory only the present and the most recent feature values. This can result in fast execution time and a low memory input.

In one embodiment, the feature generator 122 includes a memory 134. The memory 134 includes a first memory block 136 and a second memory block 138. The feature generator 122 advantageously utilizes the memory 134 to efficiently and effectively compute features and to store feature values.

In one embodiment, the memory block 136 is configured to store feature generation data 140. The feature generation data 140 contains instructions for computing the features that will be included in the feature data 128.

In one embodiment, the memory block 138 stores feature data 128. The feature data 128 corresponds to the values of the computed by the feature generation data 140. Accordingly, when the feature generator 122 calculates the value of the feature utilizing the feature generation data 140, the feature generator 122 can store the value of the feature in the feature data 128 in the memory block 138. The feature data 128 may store the ambient temperature Ta value, the object temperature To value, a recursive variance value, a variance value, a recursive maximum value, a recursive minimum value, a derivative value, or other feature values. The feature data 128 may include a current feature value and the most recent previous feature value for each feature. As set forth previously, the sensor data 117 may correspond to features in the feature data 128.

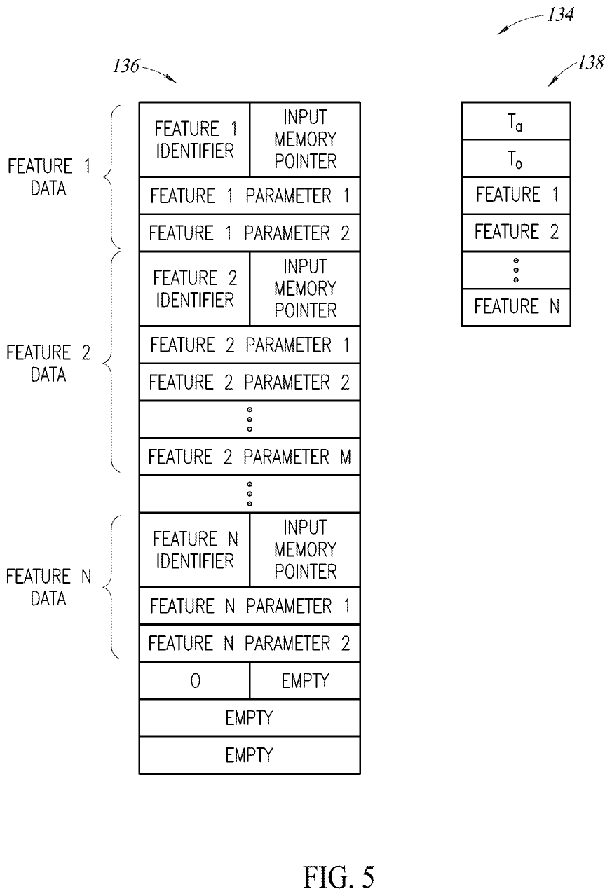

The separation of the memory 134 into a memory block 136 and a memory block 138 can be highly advantageous, resulting in very efficient use of memory and rapid computation of features. For example, the feature generation block 140 may include, for each feature, a plurality of words of memory. A first word of memory may include a feature code corresponding to an identification of the feature. A second word of memory may include one or more pointers that point to a feature value in the feature data 128 that is used in computing the current feature. Further details regarding the pointers will be provided below. One or more next words of data can correspond to feature parameter data. The feature parameter data indicates how a particular parameter of the feature is to be calculated. After the final feature parameter data, data relating to computation of the next feature follows in the memory. Further details regarding feature generation data 140 are provided in relation to FIG. 5.

Further details regarding the generation of feature values can be found in U.S. patent application Ser. No. 17/360,977, filed on Jun. 28, 2021 and titled “METHOD, SYSTEM, AND CIRCUIT FOR EXTRACTING FEATURES FOR USE IN EMBEDDED ARTIFICIAL INTELLIGENCE MECHANISMS”. U.S. patent application Ser. No. 17/360,977 is hereby incorporated by reference in its entirety.

FIG. 4 illustrates a single memory 134 with a first memory block 136 and a second memory block 138. However, in one embodiment, the memory block 136 may be a separate memory from the memory block 138. The memory block 136 may be a same type of memory as the memory block 138 or a different type of memory as the memory block 138. In one embodiment, the memory block 136 is random access memory (RAM). The memory block 136 may include static RAM (SRAM), dynamic RAM (DRAM), flash RAM, or other types of RAM. In one embodiment, the memory block 138 can include RAM, such as SRAM, DRAM, flash RAM, or other types of RAM.

FIG. 5 is a block diagram of the memory 134 of a feature generator 122, according to one embodiment. The memory 134 of FIG. 5 is one example of the memory 134 of FIG. 4. The first memory block 136 corresponds to feature generation data 140. The second memory block 138 corresponds to feature data 128.

The memory block 138 includes a plurality of feature values. The memory block 138 does not include instructions for computing the feature values. Instead, the memory block 138 only includes the actual values generated for each feature. Accordingly, the memory block 138 includes the feature data 128.

In the example of FIG. 5, the memory block 138 includes the sensor data values Ta and To, and N features generated from the sensor data values Ta and To. Accordingly, the memory block 138 stores N+2 feature values, including Ta, To, and the N features generated from Ta and To. In one embodiment, the memory block 138 stores the current value of each feature in the most recent value of each feature.

The memory block 136 includes data for generating the feature values that will be stored in the memory block 138. Because Ta and To are simply received from the sensor 104, the memory block 136 may not include instructions for generating Ta and To. Instead, the memory block 136 includes instructions for generating the N features based on the sensor data.

Each feature may be generated based on the values of one or more other features. For example, a first feature may be calculated based on the values of Ta, To, and the value of the second feature. As will be described in more detail below, the arrangement of the memory 136 advantageously enables retrieval of feature values from the memory block 138 for use in computing current values of the features.

In one embodiment, the feature generation data 140 includes, for each of the N features, a feature identifier, an input memory pointer, and one or more feature parameters. The feature identifier may include a byte of data identifying the feature. The input memory pointer may include a byte of data indicating a location in the memory block 138. In particular, the input memory pointer points to the value of another feature that will be utilized in computing the feature value. For example, the input memory pointer four feature one may point to the value of feature N in the memory block 138. The value of feature N can then be retrieved for computing the value feature one. The feature generation data for each feature may include one or more feature parameters. The feature parameter indicates instructions for computing one or more parameters associated with computing the final value for the current feature.

In the example of FIG. 5, the feature data for feature one includes the feature identifier for feature one, an input memory pointer for feature one, data for computing a first parameter of feature one, and data for computing a second parameter feature one. The feature data for feature two includes a feature identifier, an input memory pointer, and data for computing M parameters of feature two. The feature data for feature N includes the identifier for feature N, an input memory pointer for feature N, and data for computing to parameters of feature N. In practice, the feature data for a given feature can include a single feature parameter or multiple feature parameters.

In one embodiment, the memory block 136 is arranged sequentially. For example, a first by the data may correspond to the feature identifier for feature one, a next byte of data may correspond to an input memory pointer for feature 1, one or more next bytes of data may correspond to parameter one of feature 1, and one or more next bytes of data may correspond to parameter to of feature 1. After the final parameter feature 1, a next byte of data corresponds to the feature identifier of feature 2. This continues in sequence until the final feature parameter of feature N. In one embodiment, after the final feature parameter of feature N, a next bytes of data is 0. The byte of data including 0 indicates the end of the feature data and all remaining bytes of data may be empty.

In one embodiment, the configuration data of the feature generator stores data indicating when the feature data of one feature begins and when the feature data of a next feature begins. Accordingly, the memory block 136 can be densely written in sequences of bytes as described above. Other configurations of the memory block 136 and the memory block 138 can be utilized without departing from the scope of the present disclosure.

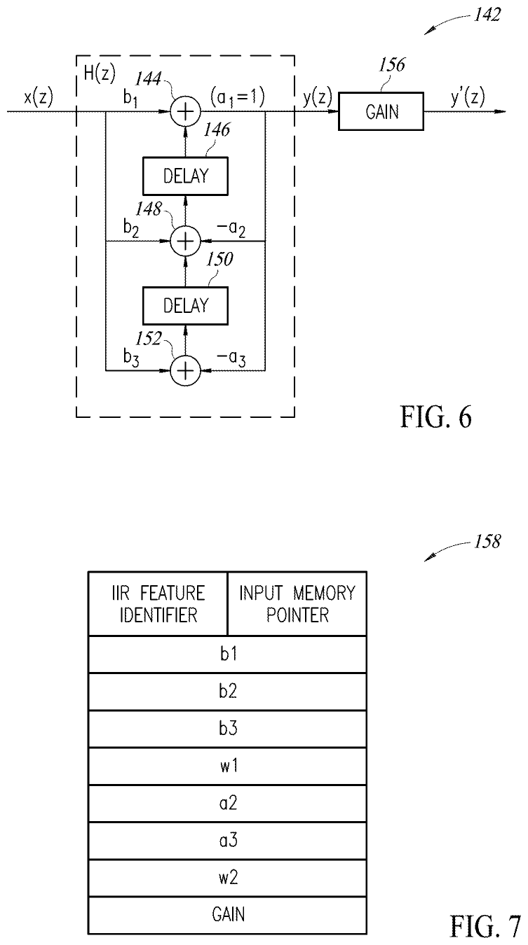

FIG. 6 is a schematic diagram of a biquad cell 142 of a feature generator 122, according to one embodiment. The biquad cell 142 is utilized to generate a feature for the feature data 128. In particular, the biquad cell 142 is utilized to generate an infinite impulse response (IIR) data value. The biquad cell includes a filter block H(z) and a gain 156. The filter block H(z) receives a data value x(z) and outputs a filtered data value y(z). The gain block 156 receives the filtered data value y(z) and generates a data value y′(z) after applying a gain value to y(z). y′(z) corresponds to the output of the feature block 142 and may correspond to a feature of the feature data.

The filter block H(z) includes a first summer 144, a delay block 146, a second summer 148, a delay block 150, and a third summer 152. Parameters b1 and a1 are associated with the first summer 144. Parameters b2 and a2 are associated with the second summer 148. Parameters b3 and a3 are associated with the third summer 152. A delay value w1 is associated with the delay block 146, a delay value w2 is associated with the delay block 150. A gain value is associated with the gain block 156.

In one embodiment, the filter 142 is configured to remove a DC value from the object temperature value To. The DC component of To may not care useful information. The biquad filter 142 may be utilized to remove the DC component of To.

FIG. 7 is a block diagram illustrating the feature data 158 associated with the biquad filter 142. The feature data 158 as part of the feature data 140 stored in the memory block 136. Because the biquad filter 142 is utilized to generate a feature for the feature data 128, the memory block 136 includes feature data for generating the feature value. The feature data 158 includes the IIR feature identifier, an input memory pointer for retrieving the feature value or values that will be utilized in generating the output feature value, and the feature parameters. In particular, the feature parameters include the values of b1, b2, b3, w1, a2, a3, w2, and gain associated with the biquad cell 142. These feature parameter values are utilized to generate the output of the biquad filter 142.

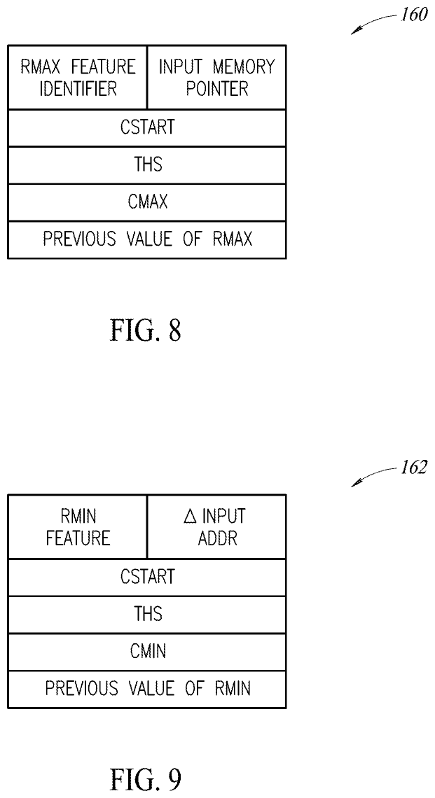

FIG. 8 is a block diagram of feature data 160 associated with generating a recursive maximum (Rmax), according to one embodiment. The feature data 160 is part of the feature data 140 stored in the memory block 136. The recursive maximum may correspond to an envelope above one or both of To and Ta. The feature data 160 includes the recursive maximum feature identifier, an input memory pointer, and four feature parameters. The first feature parameter is Cstart and corresponds to a fixed value that does not get updated. The second feature parameter is THS, corresponding to a threshold value that is not updated. The third feature parameter is Cmax. Cmax may initially be set to the value of Cstart and is updated with each iteration. The fourth parameter is the previous value of the recursive maximum and may initially be set to the value of THS. Other parameters can be utilized for calculating the recursive maximum.

In one embodiment, the recursive maximum is computed in the following manner. For a given input value xi, it is determined whether xi is greater than the most recent previous value of the recursive maximum (Rmaxᵢ₋₁). If xi is greater than the most recent value of the recursive maximum, then the recursive maximum (Rmaxᵢ) is set to xi and Cmax is set to Cstart. If xi is less than or equal to the most recent recursive maximum, then the recursive maximum is calculated in the following manner:

Rmaxᵢ=THS+(Rmaxᵢ₋₁−THS)*Cmax.

Cmax is set to Cmax*Cstart. If Rmaxᵢ is less than THS, then Rmaxᵢ is set to THS. Accordingly, Rmax cannot be lower than THS. Xi may correspond to the output of the filter 142 of FIG. 6. Accordingly, the memory pointer for Rmax may point to the feature value associated with the output of the filter 142.

FIG. 9 is a block diagram of feature data 162 associated with generating a recursive minimum (Rmin), according to one embodiment. The feature data 162 is part of the feature data 140 stored in the memory block 136. The recursive minimum may correspond to an envelope below one or both of To and Ta. The feature data 162 includes the recursive minimum feature identifier, an input memory pointer, and four feature parameters. The first feature parameter is Cstart and corresponds to a fixed value that does not updated. The second feature parameter is THS, corresponding to a threshold value that is not updated. The third feature parameter is Cmin. Cmin may initially be set to the value of Cstart and is updated with each iteration. The fourth parameter is the previous value of the recursive minimum and may initially be set to the value of THS. Other parameters can be utilized for calculating the recursive minimum. Cstart and THS for Rmin may be different than Cstart and THS for Rmax.

In one embodiment, the recursive maximum is computed in the following manner. For a given input value xi, it is determined whether xi is less than the most recent previous value of the recursive minimum (Rminᵢ₋₁). If xi is less than the most recent value of the recursive minimum, then the recursive minimum (Rminᵢ) is set to xi and Cmin is set to Cstart. If xi is greater than or equal to the most recent recursive minimum, then the recursive minimum is calculated in the following manner:

Rminᵢ=THS−(THS−Rminᵢ₋₁)*Cmin.

Cmin is set to Cmin*Cstart. If Rminᵢ is greater than THS, then Rminᵢ is set to THS. Accordingly, Rmax cannot be greater than THS.

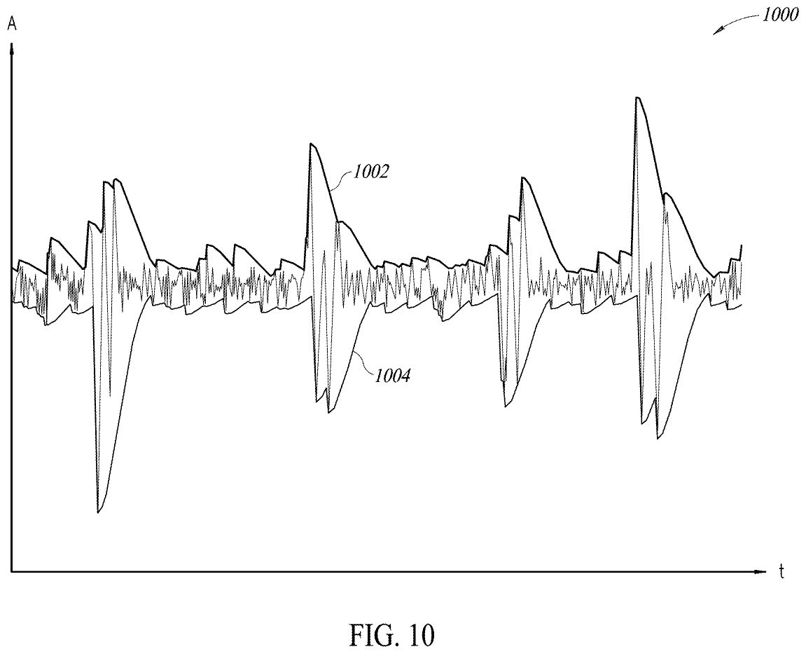

FIG. 10 is a graph 1000 illustrating Rmax and Rmin, according to one embodiment. The graph 1000 may include a filter value of To. Rmax is shown in the curve 1002 corresponding to an envelope above the filtered value of To. Rmin is shown in the curve 1004 corresponding to an envelope below the filtered value of To. Rmax is an envelope detector above a threshold. Rmin is an envelope detector below a threshold. Rmax and Rmin can be used for event detection to smooth a fast event in the field of view of a sensor 104.

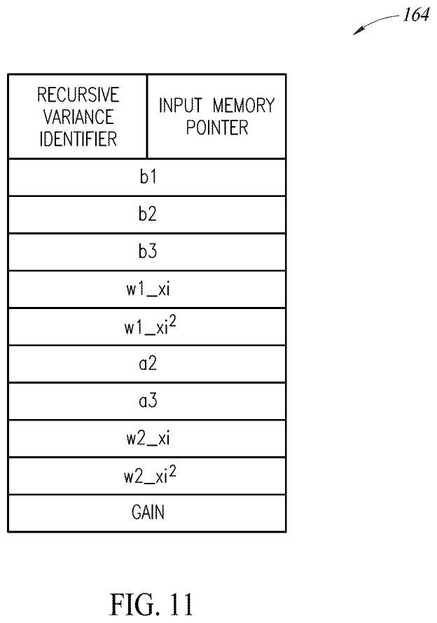

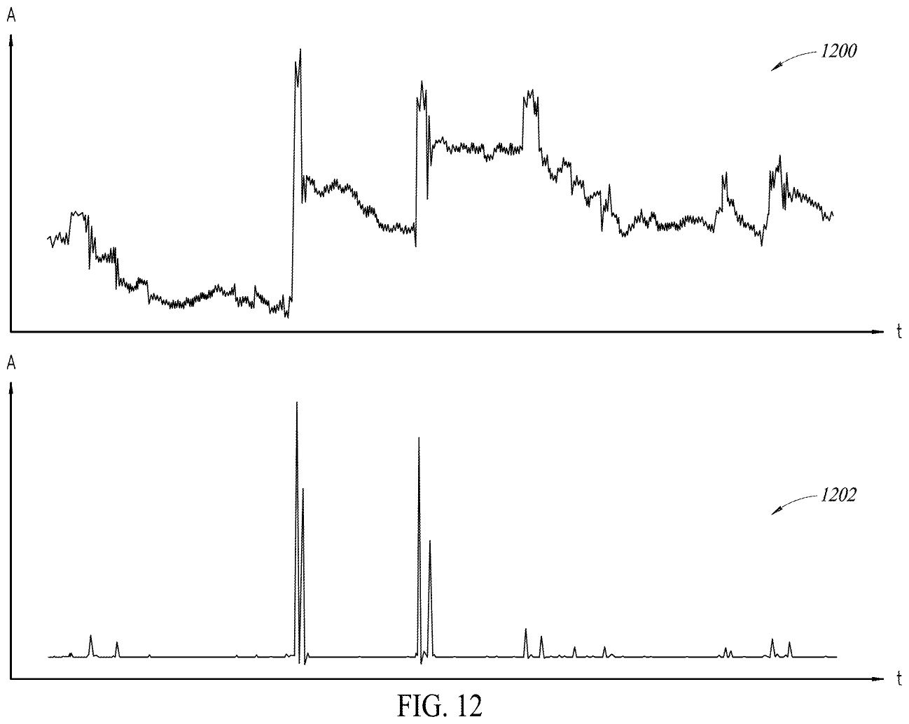

FIG. 11 is a block diagram of feature data 164 associated with calculating a recursive variance feature, according to one embodiment. The feature data 164 is part of the feature data 140. The recursive variance may be calculated with a biquad filter similar to the biquad filter 142 of FIG. 6 that was utilized to calculate the IIR filter value. The recursive variance (Rvar) can be calculated in the following manner:

IIR_{LP}[xi²]−IIR_{LP}²[xi],

where xi is an input data value and IIR_{LP} is the output data value of a low-pass IIR filter. The feature data 164 includes a recursive variance identifier, an input memory pointer, and a parameters b1, b2, b3, w1_xi, w1_xi², a2, a3, w2_xi, w2_xi², and gain. Accordingly, the feature data 164 has similar memory mapping as the IIR filter and may include the same or similar coefficients. The feature data 164 may utilize partial results (w1, w2), one for xi² and the other for xi.

FIG. 12 includes a graph 1200 of the object temperature To and a graph 1202 of the recursive variance of the object temperature To, according to one embodiment. The variance allows easy discrimination of the movement of the person. Furthermore, variance can indicate whether there is a small movement or change of scenario (i.e., sitting down or getting up). The variance alone may not be sufficient to discriminate absence from presence of a still person.

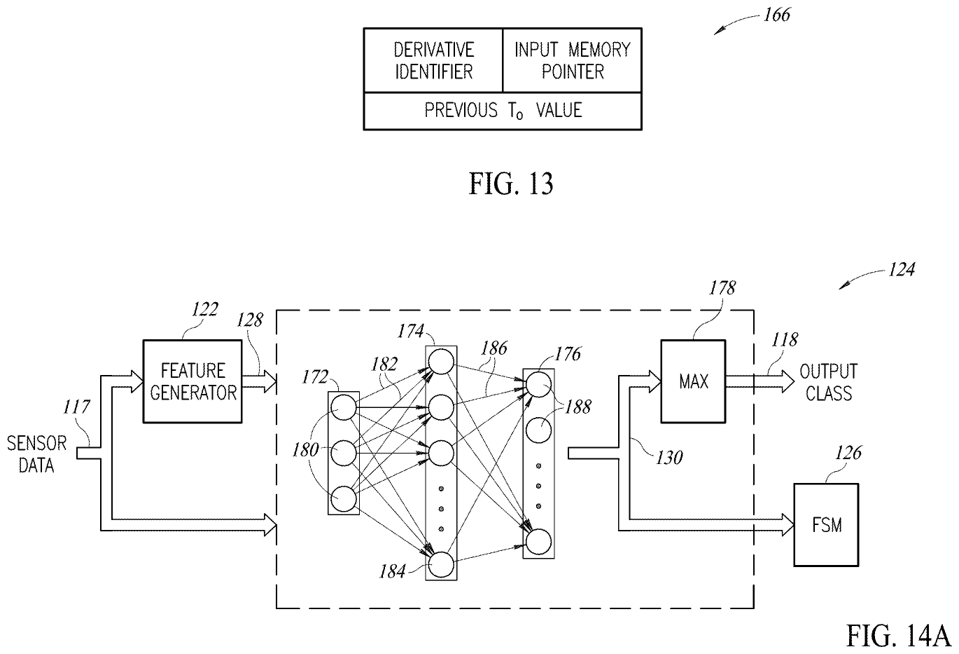

FIG. 13 is a block diagram of feature data 166 associated with computing a derivative feature, according to one embodiment. The feature data 166 may be part of the feature data 140. The feature data 166 includes a derivative feature identifier, an input memory pointer, and a single feature parameter. The input memory pointer may retrieve a feature value z[i] from the memory 138. In one example, z[i] may correspond to To, a filtered version of To, or another type of the feature. In the example in which z[i] is a current value of To, the feature parameter may correspond to the previous value of To (z[i-1]. The derivative of z[i] may correspond to the difference between z[i] and z[i-1]. The time discreet derivative for sloped analysis may be very useful.

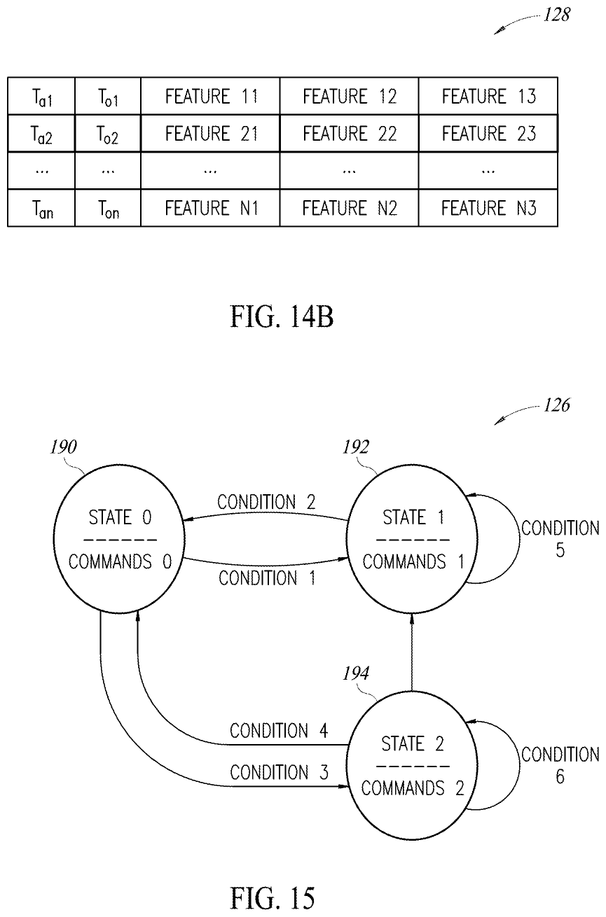

FIG. 14A is a block diagram of a neural network 124, according to one embodiment. The neural network 124 is one example of a neural network 124 of FIG. 3. The neural network 124 receives one or both of feature data 128 and raw sensor data 117 and generates classification data 130. If the neural network 124 is the final selected block of the configurable digital analysis block 106, then the classification data 130 is processed to generate final classification data 118. If the finite state machine 126 is the final selected analysis block of the configurable digital analysis block 106, then the neural network 124 outputs a classification data 130 to the finite state machine 126.

In the example of a sensor device configured to detect whether a user is present in the field of view of a sensor 104, the possible classes in the classification data 130 may include “present” or “not present”. In the example of a sensor device configured to count the number of people entering and exiting an area, the possible classes may be “left to right crossing”, “right to left crossing”, and “no crossing”. Other types of classifications may be used for other types of situations and other types of sensors.

In one embodiment, when the neural network 124 passes classification data 130 to the finite state machine 126, the neural network passes the probability for each class. For example, the neural network 124 may generate, for each possible class, a score indicating the likelihood that the sensor data or feature data belongs to that class. The score may be between 0 and 1, with a higher score indicating a higher probability. The score for each class may be provided to the finite state machine 126. However, when the neural network 124 is the final selectable analysis block, the neural network 124 may output classification data 118 which only indicates the class with the highest likelihood score.

In one embodiment, the neural network 124 is a quantized neural network. The quantized neural network includes an input layer 172, a hidden layer 174, and an output layer 176. The input layer includes neurons 180. The hidden layer 174 includes neurons 184. The output layer includes neurons 188. In practice, the input layer 172 may include a respective neuron 180 for each data field of the feature vectors provided as input. In practice, the output layer 176 may include a respective neuron 188 for each possible class.

Each neuron 180 of the input layer 172 is connected to each of the neurons 184 of the hidden layer 174 by an edge 182. Each edge may be associated with a mathematical function that takes the value at the neuron 180 and generates a value provided to the neuron 184. Each edge 182 is associated with one or more weight values. The weight values corresponds to the scalar values that are adjusted during the machine learning process, as will be described in more detail below. Each neuron 184 of the hidden layer 174 is connected to each neuron 188 of the output layer 176 by an edge 186. After training is complete a series of feature vectors or sets of sensor data 117 are provided as inputs to the neural network 124. The neural network 124 the data values are provided to the input layer 180 and process through the edges and neurons of the neural network 124 until the final values at the neurons 188 of the output layer 176 are generated. If the neural network 124 is the final analysis block, then the classification data is passed from the output layer to the max operator 178. The max operator 178 outputs the output classification with the highest value from the output layer 176 as the classification data 118.

In one embodiment, the input layer corresponds to standardization on inputs. Standardization may be implemented as a z-score with the standard deviation and means precalculated the saved the memory as parameters.

Training set data is utilized to train the neural network 124 during the machine learning process. The training set data includes a plurality of sets of feature vectors (or a plurality of sets of sensor data 117, as the case may be). The training set data also includes a label for each set of feature vectors. The label corresponds to the correct classification for that set of feature vectors. In the example of a presence detector, the label indicates whether or not that set of feature vectors was generated with a user present.

During the training process, the sets of feature vectors are passed through the neural network 124. The neural network generates classification data based on the feature vectors. A training module compares the classification data to the labels and generates an error function. The smaller the error function, the more closely the classification data matches the labels. The weighting values associated with the edges 182 and 186 are then adjusted and the sets of feature vectors are passed through the neural network 124 and classification data is again generated. An error function is also generated. The weighting values are adjusted again and the process is repeated until a set of weight values is found that results in classification data that matches the label data within a threshold tolerance. At this point, the neural network 124 is trained and is ready to be put to use generating classification data based on feature vectors.

While the neural network 124 of FIG. 14A includes an input layer 172, a hidden layer 174, and an output layer 176, in practice, a neural network 124 can have different numbers of layers than shown in FIG. 14A. Furthermore, the neural network 124 can include other types of neural networks or even other types of machine learning based analysis models.

FIG. 14B is a representation of feature data 128 provided to a neural network 124, according to one embodiment. Each row of the feature data 128 corresponds to a feature vector generated for a particular sample of sensor data 117. In the example of FIG. 14B, each feature vector includes five data fields. A first data field is the ambient temperature Ta, a second data field is the object temperature To, a third data field is Feature 1, a fourth data field is Feature 2, a fifth data field is Feature 3. The feature data 128 includes n feature vectors. This may correspond to a window of input data that will be provided to the neural network 124 (or to the finite state machine 126, as the case may be) for classification.

FIG. 15 is a representation of a finite state machine 126, according to one embodiment. The finite state machine may correspond to a Moore machine is output values are determined only by its current state. Parameters that can be set can include a state number, an arc command, an arc condition, and a state command. The finite state machine 126 may utilize a state memory used for logic conditions, a command memory used for arc and state commands, and an input memory that may receive classification data 130 from the neural network 124, sensor data 117, feature data 128, timer data, constant inputs, or other types of data.

The finite state machine 126 includes three states: state 190 (state 0) state 192 (state 1) and state 194 (state 2). The finite state machine also includes a plurality of arc conditions or arc commands. The arc conditions are conditions that, if satisfied, cause the transition from one state to another or cause to remain at the present state. Each state includes one or more state commands.

In one embodiment, the finite state machine 126 is configured to output a classification indicating whether or not an individual is present in the field of view of a sensor 104. In this example, state 190 is a “wait” state, state 192 is a “presence” state (i.e., user is present), and state 194 is a “no presence” state (i.e., user is not present).

In one embodiment, the wait state 190 includes two commands: a set timer P command and a set timer NP command, where P indicates presence of the user and NP indicates no presence. The presence state 192 includes a command “timer p” and the command output class=1, where an output class of 1 corresponds to a classification of “user is present”. The no presence state 194 includes a command timer NP and the command output class=0, where an output class of zero corresponds to a classification of “user is not present”.

In one embodiment, condition 1 corresponds to a condition that can cause a transition from state 190 to state 192. Condition 1 may have the following form:

ML_{P}*P1≥ML_{NP}*P2,

where ML_{P} is a value from the classification data 130 from the neural network 124 indicating a probability that the user is present, ML_{NP} is a value from the classification data 130 indicating a probability that the user is not present, P1 is a weighting value, and P2 is a weighting value. In other words, if the probability that the user is present multiplied by the first weighting value is greater than or equal to the probability that the user is not present multiplied by a second weighting value, then the state transitions from state 190 to state 192 (i.e., user is present).

In one embodiment, condition 2 is a condition that causes a transition from state 192 to state 190. Condition 2 may indicate that if timer p is equal to 0, and if a feature value corresponding to the high-pass filtering of To is greater than THS, then the state transitions from state 192 to stay 190.

In one embodiment, condition 3 corresponds to a condition that can cause a transition from state 190 to state 194. Condition 3 may have the following form:

ML_{P}*P1≤ML_{NP}*P2.

In other words, if the probability that the user is present multiplied by the first weighting value is less than or equal to the probability that the user is not present multiplied by a second weighting value, then the state transitions from state 190 to state 194 (i.e., user is not present).

In one embodiment, condition 4 is a condition that causes a transition from state 194 to state 190. Condition 4 may indicate that if timer np is equal to 0, and if a feature value corresponding to the high-pass filtering of To is greater than THS, then the state transitions from state 192 to stay 190.

In one embodiment, condition 5 is a condition that causes the state to remain at state 192. Condition 5 may indicate that the state should remain at state 192 if the high-pass filter feature of To is less than THS or if timer p does not equal 0.

In one embodiment, condition 6 is a condition that causes the state to remain at state 194. Condition 6 may indicate that the state should remain at state 194 if the high-pass filter feature of To is less than THS or if timer np does not equal 0.

The finite state machine 126 can have other configurations than shown in FIG. 15 and described above. For example, the finite state machine 126 can have other states, other state commands, and other conditions without departing from the scope of the present disclosure.

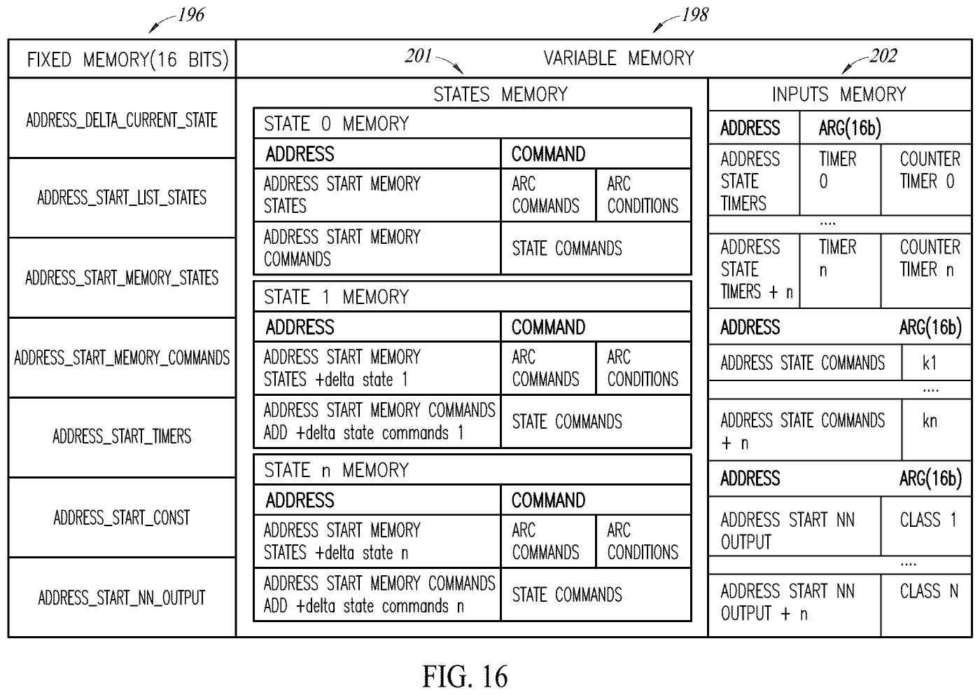

FIG. 16 is a block diagram of a memory 195 of a finite state machine 126, according to one embodiment. The memory 195 can include a fixed memory 196 and the variable memory 198. The fixed memory 196 may correspond to a 16 bit memory including address Delta current state, address start list states, address start memory states, address start memory commands, address start timers, address start constants, and address start neural network outputs. Other types of data can be stored in the fixed memory 196 without departing from the scope of the present disclosure. Furthermore, the fixed memory 196 can have other sizes or formats without departing from the scope of the present disclosure.

The variable memory 198 may correspond to RAM and may include a states memory 201 and an inputs memory 202. The states memory 201 can include a memory allocation for each of n states of a finite state machine. The state memory 201 can be arranged sequentially in a similar manner as the feature generation data 136. The feature data for each feature can include address data, are command data, arch conditions data and state commands. The input memory can include address data, timer data, counter timer data, state commands data, the neural network output data, neural network classification data, or other types of data.

In one embodiment, the command data can include commands for testing inputs, commands for comparing inputs, commands for testing the timer, commands for setting an output class, commands for decreasing the timer value, commands for setting a timer, commands for resetting a recurrent neural network, commands for setting an interrupt, commands for setting the finite state machine timer, commands for generating a prediction or classification for the finite state machine, or other types of commands. Command data can also include masks associated with each state command.

In one embodiment, a sensor device includes a sensor configured to generate sensor data and a configurable digital analysis block configured to receive the sensor data and to generate a classification based on the sensor data. The configurable digital analysis block includes a plurality of selectable analysis blocks that can be selectively included or excluded from participating in generating the classification.

A method, comprising receiving, with a configurable digital analysis block of a sensor device, configuration data indicating which of a plurality of selectable analysis blocks of the configurable digital analysis block will participate in generating a classification. The method includes generating, with a sensor of the sensor device, sensor data, and generating, with the configurable digital analysis block, the classification based on the sensor data.

In one embodiment, a method includes generating sensor data with an infrared sensor of a sensor device and generating, from the sensor data, feature data with a feature generator of the sensor device. The method includes generating, with a neural network of the sensor device, first classification data based on the feature data and generating, with the finite state machine of the sensor device, second classification data based on the first classification data.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A sensor device, comprising:
a sensor configured to generate sensor data; and
a configurable digital analysis block configured to receive the sensor data and to generate a classification based on the sensor data, the configurable digital analysis block including a plurality of selectable analysis blocks that can be selectively included or excluded from participating in generating the classification.

2. The sensor device of claim 1, wherein the selectable analysis blocks include:
a feature generator configured, when selected for participation in generating the classification, to receive the sensor data, to generate a plurality features from the sensor data, and to output a feature vector including the plurality of features;
a neural network configured, when selected for participation in generating the classification, to selectively receive either the sensor data or the feature vector, and to selectively generate either the classification or a pre-classification; and
a finite state machine configured, when selected for participation in generating the classification, to selectively receive one or more of the sensor data, the feature data, and the pre-classification data and to generate the classification data.

3. The sensor device of claim 2, wherein the feature generator includes a first memory configured to store, for each of the plurality of features, data for generating the feature.

4. The sensor device of claim 3, wherein the feature generator includes a second memory configured to store values of the features.

5. The sensor device of claim 4, wherein the feature data includes, for at least one of the features, a pointer indicating an address of a feature value in the second memory for computing the at least one of the feature.

6. The sensor device of claim 5, wherein the first memory is a random access memory.

7. The sensor device of claim 2, wherein the neural network is a quantized neural network trained with a machine learning process to generate the pre-classification data.

8. The sensor device of claim 7, wherein the pre-classification data includes a probability score for each possible class.

9. The sensor device of claim 8, wherein the neural network includes a max operator configured to receive the pre-classification data and to output, as the classification, the class with the highest probability score.

10. The sensor device of claim 2, wherein the finite state machine includes:
a variable memory configured to store states data associated with states of the finite state machine; and
a fixed memory including address data associated with the states data.

11. The sensor device of claim 10, wherein the variable memory stores inputs data associated with inputs of the states.

12. The sensor device of claim 1, wherein the sensor is a passive infrared sensor and the configurable digital analysis block is configured to generate the classification indicating whether or not a person is in a field of view of the passive infrared sensor.

13. The sensor device of claim 1, wherein the sensor is a passive infrared sensor and the configurable digital analysis block is configured to generate the classification indicating whether or not a person has crossed through a field of view of the passive infrared sensor.

14. A method, comprising:
receiving, with a configurable digital analysis block of a sensor device, configuration data indicating which of a plurality of selectable analysis blocks of the configurable digital analysis block will participate in generating a classification;
generating, with a sensor of the sensor device, sensor data; and
generating, with the configurable digital analysis block, the classification based on the sensor data.

15. The method of claim 14, wherein the selectable analysis blocks include:
a feature generator configured, when selected for participation in generating the classification, to receive the sensor data, to generate a plurality features from the sensor data, and to output a feature vector including the plurality of features;
a neural network configured, when selected for participation in generating the classification, to selectively receive either the sensor data or the feature vector, and to selectively generate either the classification or a pre-classification; and
a finite state machine configured, when selected for participation in generating the classification, to selectively receive one or more of the sensor data, the feature data, and the pre-classification data and to generate the classification data.

16. The method of claim 15, wherein generating sensor data includes generating an object temperature and an ambient temperature.

17. The method of claim 15, comprising training the neural network with a machine learning process to generate the classification.

18. A method, comprising:
generating sensor data with an infrared sensor of a sensor device;
generating, from the sensor data, feature data with a feature generator of the sensor device;
generating, with a neural network of the sensor device, first classification data based on the feature data; and
generating, with the finite state machine of the sensor device, second classification data based on the first classification data.

19. The method of claim 18, comprising:
receiving the feature data and the first classification data with the finite state machine; and
generating the second classification data with the finite state machine.

20. The method of claim 19, wherein the second classification data indicates whether or not a person is present.
